(19) United States
(12) Patent Application Publication
(10) Pub. No.: US 2024/0013263 A1
(43) Pub. Date: Jan. 11, 2024

(54) MACHINE LEANING LEAD CONVERSION PROBABILITY AND COMMUNICATION OPTIMIZATION FOR USERS OF AN ONLINE SYSTEM

(71) Applicant: Tekion Corp, Pleasanton, CA (US)

(72) Inventors: Gaurav Gupta, Pleasanton, CA (US); Saikumaar Nagarajan, Bangalore (IN); Nitika Gupta, Bengaluru / Karnataka (IN); Ved Surtani, Gurgaon / Haryana (IN)

(21) Appl. No.: 17/859,817

(22) Filed: Jul. 7, 2022

(51) Int. Cl. G06Q 30/02; G06N 20/20; G06F 11/34

(52) U.S. Cl. CPC G06Q 30/0281; G06N 20/20; G06F 11/3438

(57) ABSTRACT

The online system detects a user interaction between a first user and the online system, and retrieves a set of attributes of the user interaction. Based on the retrieved set of attributes of the user interaction, the online system periodically determines, using a first trained model, a lead score indicative of a likelihood that the user interaction will result in a conversion. If the lead score is higher than a threshold value, the online system determines, using a second trained model, based on attributes of the user interaction between the first user and the online system, and user profile information for the first user, a set of communication parameters to communicate with the first user. The second trained model is trained to select the set of communication parameters to maximize the likelihood of conversion with a least number of communications with the first user associated with the user interaction.

### BACKGROUND

An online system may provide products or services for selection by its users. For example, an online system may enable users to select vehicles for offer by the online system. Online systems provide user interfaces to users that allow them to select the products or services that are available on the online system. However, users may browse through the available products or services of the online system without resulting in a conversion immediately. Instead, the online system may follow up with the user for a period of time until the user is eventually converted. However, due to the large number of users browsing the online system, the online system may not be able to follow up on every lead. For example, given the large number of users browsing the online system, a large amount of processing power, network bandwidth, and the like may be used to follow up on every lead that is generated in the online system. Accordingly, the online systems may benefit from an algorithm that prioritizes leads that are likely to convert and deprioritizes leads that are unlikely to convert. Moreover, the online system may benefit from an algorithm that optimizes the communications between the online system and users that are likely to convert, thus reducing the amount of processing power used for acting upon the leads and reducing the bandwidth used for following up on the leads.

### SUMMARY

The online system presented herein provides an improved user interface to a user by providing a set of communication parameters and a set of communication suggestions for communicating with other users interacting with the online system. Moreover, the online system reduces the amount of computing power, communication bandwidth, and/or storage used for processing and following up on leads generated by users browsing the online system.

The online system detects a user interaction between a first user and the online system. The online system then retrieves a set of attributes of the user interaction. Based on the retrieved set of attributes of the user interaction, the online system periodically determines, using a first trained machine learning (ML) model, a lead score indicative of a likelihood that the user interaction will result in a conversion. In some embodiments, the first trained model is trained using a first training dataset having a set of past user interactions with the online system. Each past user interaction may include a set of dynamic features describing a set of communications associated with the past user interaction, and a set of static features describing the set of attributes of the user interaction.

If the lead score is higher than a threshold value, the online system additional determines, using a second trained ML model, a set of communication parameters to communicate with the first user. The online system may determine the set of communication parameters based at least in part on attributes of the user interaction between the first user and the online system, and user profile information for the first user. In some embodiments, the second trained model is trained to select the set of communication parameters to increase the likelihood of conversion of the first user. In one embodiment, the second trained model is trained to select the set of communication parameters to maximize the likelihood of conversion with a least number of communications with the first user associated with the user interaction.

In some embodiments, the online system presents the set of communication parameters to a second user of the online system to instruct the second user to communicate with the first user based on the set of communication parameters. In some embodiments, the set of communication parameters include a communication channel. For example, the set of communication parameters specifies whether to communicate with the first user via email, text, or phone call.

### BRIEF DESCRIPTION OF THE DRAWINGS

FIG. 1 is a block diagram of a system environment in which an online system operates, according to one or more embodiments.

FIG. 2 is a block diagram of an online system, according to one or more embodiments.

FIG. 3 is a flow diagram of the lifecycle of a lead, according to one or more embodiments.

FIG. 4 is a block diagram showing an overview for following up with leads, according to one or more embodiments.

FIG. 5 is a flow diagram of a process for following up on leads, according to one or more embodiments.

FIG. 6 is a system diagram of a computer system, according to one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

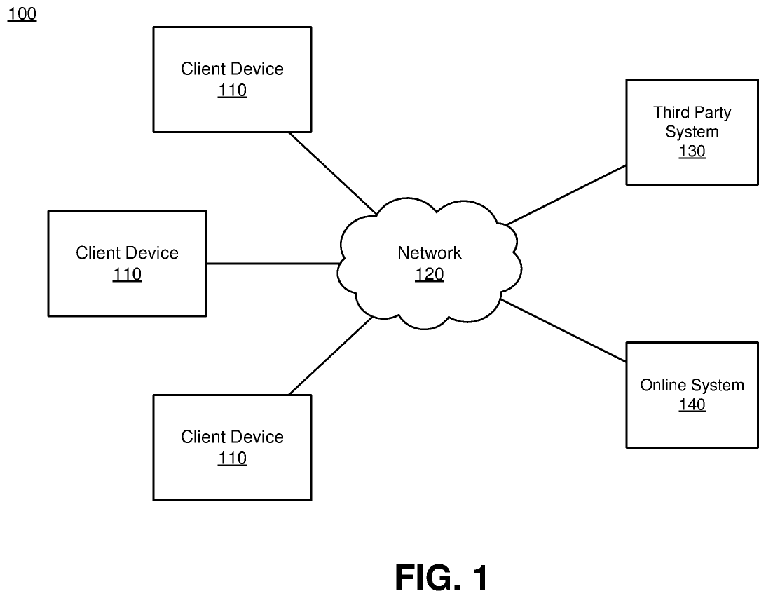

FIG. 1 is a block diagram of a system environment 100 for an online system 140, according to one or more embodiments. The system environment 100 shown by FIG. 1 comprises one or more client devices 110, a network 120, one or more third-party systems 130, and the online system 140. In alternative configurations, different and/or additional components may be included in the system environment 100. For example, the online system 140 is an electronic commerce system, or another system providing content or products to users.

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

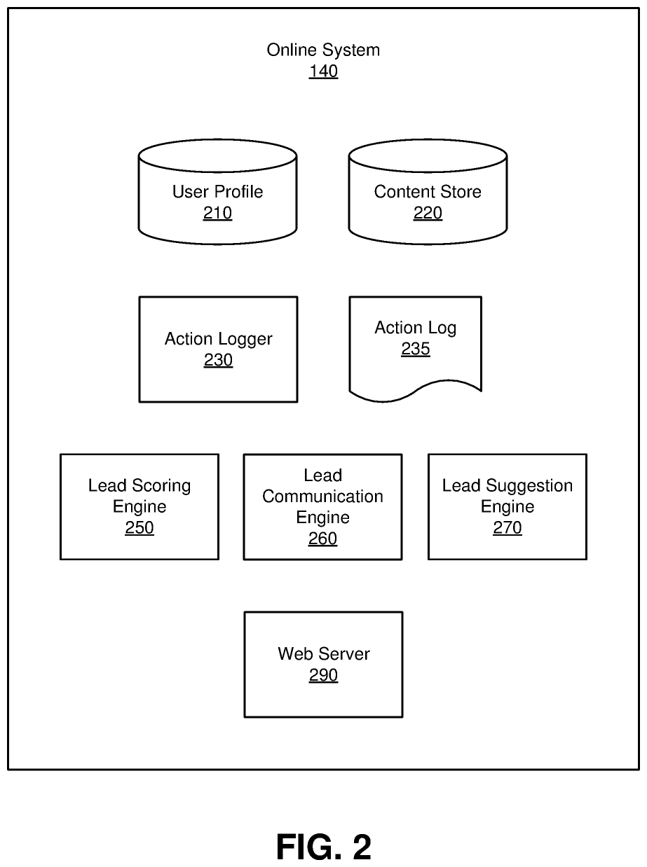

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device. In other embodiments, a third-party system 130 provides content or other information for presentation via a client device 110. A third-party system 130 may also communicate information to the online system 140, such as advertisements, content, or information about an application provided by the third-party system 130.

FIG. 2 is a block diagram of an architecture of the online system 140, according to one or more embodiments. The online system 140 shown in FIG. 2 includes a user profile store 210, a content store 220, an action logger 230, an action log 235, a lead scoring engine 250, a lead communication engine 260, a lead suggestion engine 270, and a web server 290. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 210. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 210 may also maintain references to actions by the corresponding user performed on content items in the content store 220 and stored in the action log 235.

The content store 220 stores objects that each represent various types of content or products offered by the online system 140. For example, content or products offered by the online system 140 may include vehicles for sale or lease to users of the online system. Each object may include multiple components such as a title or name of the content or product associated with the object, a description of the content or product associated with the object, one or more photographs or videos of the content or product associated with the object, a price associated with the content or product associated with the object, etc.

The online system 140 may retrieve one or more specific components of an object associated with a content item or product for presentation. For example, the online system 140 may identify a name, description, and an image for a product and provide the name, description, and the image for presentation rather than the object in its entirety.

The action logger 230 receives communications about user actions internal to and/or external to the online system 140, populating the action log 235 with information about user actions. Examples of actions include accessing pages associated with a content item or product, sending a message to another user (such as an agent of the online system), reading a message from another user (such as an agent of the online system), and purchasing a product offered by the online system.

The action log 235 may be used by the online system 140 to track user actions on the online system 140, as well as actions on third-party systems 130 that communicate information to the online system 140. Users may interact with various objects on the online system 140, and information describing these interactions is stored in the action log 235. Additionally, the action log 235 may record a user's interactions with advertisements on the online system 140 as well as with other applications operating on the online system 140. In some embodiments, data from the action log 235 is used to infer interests or preferences of a user, augmenting the interests included in the user's user profile and allowing a more complete understanding of user preferences.

The lead scoring engine 250 receives information associated with a lead and generates a lead score for the lead indicative of the likelihood that the lead will result in a conversion. In some embodiments, the lead scoring engine 250 includes a trained lead scoring model that receives information associated with a lead as an input, and generates a lead score as an output. For example, the lead scoring model may receive information about a user or customer associated with the lead (such as user profile information for the user associated with the lead), and user activity information associated with the lead (such as information about actions performed by the user associated with the lead, or communications received from or sent to the user associated with the lead). In addition, the leas scoring model may receive information associated with a content item or product associated with the lead.

In some embodiments, the lead scoring engine 250 determines the lead score based on the number of communications between a user and the online system, a type of communication, and a sentiment for each communication between the user and the online system. In some embodiments, the lead scoring engine 250 additionally determines the lead score based on an amount of time since the lead was created (e.g., a number of days since the lead was created or since the user associated with the lead first interacted with the online system showing interest in consuming content from the online system).

In some embodiments, the lead scoring engine 250 periodically updates the lead score of each active lead. That is, the lead scoring engine 250 periodically updates the lead score of leads that have not yet been converted or abandoned. In one embodiment, the lead scoring engine 250 updates the lead scores daily (either at the beginning of the day to include events from the previous day or at the end of the day to include events that occurred during the day).

The lead scoring model is trained using information associated with past leads. Each past lead may be labeled as converted or abandoned (not converted). Alternatively, or in addition, each past lead may include an identification of a number of communications to or from the user before the lead was converted or abandoned, an amount of time from when the lead was originated until the lead was converted or abandoned, and the like.

In some embodiments, the lead scoring model receives as inputs a set of static features and a set of dynamic features associated with a lead. The set of static features includes information about user associated with the lead (e.g., user profile information about the user associated with the lead), information about the content the user is interested in, and information about the lead itself (date the lead was created, how the lead was created, etc.). In some embodiments, the set of static features do not change for the lifetime of the lead.

For example, if lead is associated with a user interested in purchasing a vehicle, the static features include information about the user such as a zip code of the user, a distance between the user and a dealership selling the vehicle, etc. Moreover, the set of static features include information about one or more vehicles (year, make, model, etc.) the user is interested in purchasing, a popularity of the one or more vehicles the user is interested in, a price or price range of the one or more vehicles the user is interested in, a variety of interested vehicles present in the inventory of the dealership, etc.

The set of dynamic features includes information about one or more interactions associated with the user lead. For example, the dynamic features include information about one or more messages sent to the user associated with the lead or received from the user associated with the lead. The set of dynamic features may include the number communications to or from the user associated with the lead, the duration or length of each communication, the type of communication, the channel of each communication, the sentiment of each communication, the frequency of communication, and the like.

In some embodiments, the dynamic features additionally include feedback provided by an agent of the online system about a communication with the user associated with the lead. After communicating with a user associated with a lead, the agent of the online system may provide feedback (e.g., through an upvote or downvote mechanism) based on their impression of the outcome of the communication.

In some embodiments, the sentiment of a communication is determined using a trained sentiment model that receives as an input a text or transcript of the communication and outputs a score indicative of whether the user had a positive reaction or a negative reaction to the communication. For instance, the text or transcript of a communication includes a transcript of a phone call with the user associated with the lead, a text of an email thread with the user associated with the lead, or a text of a text message chain with the user associated with the lead. The sentiment model may be trained using past communications that are labeled as positive or negative.

In some embodiments, each time a new communication is received from the user associated with a lead, the lead scoring engine 250 determines the sentiment of the communication based on information about the new communication, and updates the lead score of the corresponding lead based on the determined sentiment score for the new communication.

The lead communication engine 260 receives information associated with a lead and generates a set of communication parameters for communicating with the user associated with the lead. The set of communication parameters may include a communication channel for communicating with the user to increase the likelihood that the communication with the user will result in a conversion, that the communication with the user will reduce the number of steps until the lead is converted, or that the user will interact with the communication (e.g., read a message or pick up a phone call). For example, the set of communication parameters indicates whether to communicate with the user associated with the lead via email, through a text message (e.g., SMS), or over the phone.

Moreover, the set of communication parameters may include a time period for communicating with the user associated with the lead to increase the likelihood that the communication with the user will result in a conversion, that the communication with the user will reduce the number of steps until the lead is converted, or that the user will interact with the communication. For example, the set of communication parameters may indicate to communicate with the user associated with the lead in the morning or late afternoon.

In some embodiments, the lead communication engine 260 generates a new communication template based on the determined communication parameters. For example, if the lead communication engine 260 determines that the user should be contacted via email, the lead communication engine generates a new email partially filled with information associated with the lead and/or information associated with the user associated with the lead.

In some embodiments, the lead communication engine 260 includes a trained lead communication model that receives information associated with a lead as an input, and generates the set of communication parameters as an output. For example, the lead communication model may receive information about a user or customer associated with the lead (such as user profile information for the user associated with the lead). In some embodiments, the lead communication engine 260 receives information about a current state of the lead. A state of a lead may include information such as an age of the lead (e.g., how long since the lead was created), a sentiment of the lead (e.g., positive or negative sentiment based on communications with the user associated with the lead), etc. Additionally or alternatively, attributes that may be input into the lead communication model may include user demographics, historical communications (e.g., text details, call transcripts, channel, type, time of communications, and the like), and respective feedback to those historical communications. An example of a historical feedback may include notation that an email was sent to a given user two days after a lead was created with vehicle details, and the user responded to that email within five minutes with positive sentiment text.

In some embodiments, the lead communication model uses recurrent network reinforcement learning (RNRL) to maximize the likelihood of conversion of the lead with the least number of communications with the user. In some embodiments, the lead communication model selects a best next step from a set of available next steps.

In some embodiments, the communication model has a recurrent neural network (RNN) that analyzes an observed state of a lead. The observed state of a lead may include (or may be based on) a chain of events associated with a lead (e.g., retrieved from the action log 235 or user profile store 210). The chain of events may include a set of communications between the user associated with the lead and the online system, a set of interaction by the user in the online system, etc. The RNN may determine an unobserved state based on the observed state of the lead. In some embodiments, the observed state of the lead is updated periodically (e.g., daily).

The communication model may additionally have a reinforcement learning neural network (RLN or RLNN) that receives the unobserved state determined by the RNN (and optionally the observed state) of the lead, and selects an action that improves or maximizes a conversion probability. In some embodiments, the RLN selects between three possible actions to take: text message, email, or phone call. In some embodiments, the RLN may additionally select a time slot for taking the selected action.

The lead communication model is trained using information associated with past leads. Each past lead may be labeled as converted or abandoned (not converted). Alternatively, or in addition, each past lead may include an identification of a number of communications to or from the user before the lead was converted or abandoned, an amount of time from when the lead was originated until the lead was converted or abandoned, and the like.

In some embodiments, the training of the lead communication model uses a loss function that penalizes conversions with a large number of communications between the user and the online system, and rewards conversions with a low number of communications between the user and the online system.

The lead suggestion engine 270 receives information associated with a lead and generates a set of communication suggestions for communicating with the user associated with the lead. The set of communication suggestions may include talking points for communicating with the user to increase the likelihood that the communication with the user will result in a conversion, that the communication with the user will reduce the number of steps until the lead is converted.

In some embodiments, the lead suggestion engine 270 first classifies the user of a lead as either a new user or a returning user. In some embodiments, the lead suggestion engine 270 classifies a user as a returning user if the user is associated with one or more past leads that were converted. Alternatively, the lead suggestion engine 270 classifies the user as a new user or a returning user based on an amount of information available about the user by the online system 140 (e.g., as stored in the user profile store 210 and the action log 235).

In some embodiments, if the user is a returning user, the lead suggestion engine 270 may derive talking points based on previous history such as value ranges associated with a vehicle of a user, previous transaction types, user preferences, and so on.

Alternatively, if the user is a new user, the lead suggestion engine 270 finds one or more similar users based on information available about the user and generates the set of communication suggestions based on information about the similar users. In some embodiments, the users of the online system are clustered based on a set of parameters (e.g., income, zip code, age, source of lead, etc.), and a user cluster is selected based on information about the user associated with the lead. In other embodiments, the users of the online system are clustered by similarity in behavior. In this embodiment, an embedding vector modeling user behavior is determined for each user of the online system and clusters of users are determined based on the clustering of the embedding vectors. For each cluster of users, a cluster profile is generated based on the information for each user in the cluster. A cluster can then be selected by comparing the information about the user associated with the lead to the cluster profile.

Once a cluster is selected, a set of communication suggestions is generated based on information about each user in the cluster of users. For example, an average embedding vector based on the embedding vectors of each of the users in the cluster may be determines, and the set of communication suggestions may be determined based on the determined average embedding vector.

The web server 290 links the online system 140 via the network 120 to the one or more client devices 110, as well as to the one or more third-party systems 130. The web server 290 serves web pages, as well as other content, such as JAVA®, FLASH®, XML and so forth. The web server 290 may receive and route messages between the online system 140 and the client device 110, for example, instant messages, queued messages (e.g., email), text messages, short message service (SM′S) messages, or messages sent using any other suitable messaging technique. A user may send a request to the web server 290 to upload information (e.g., images or videos) that are stored in the content store 220. Additionally, the web server 290 may provide application programming interface (API) functionality to send data directly to native client device operating systems, such as IOS®, ANDROID™, or BlackberryOS.

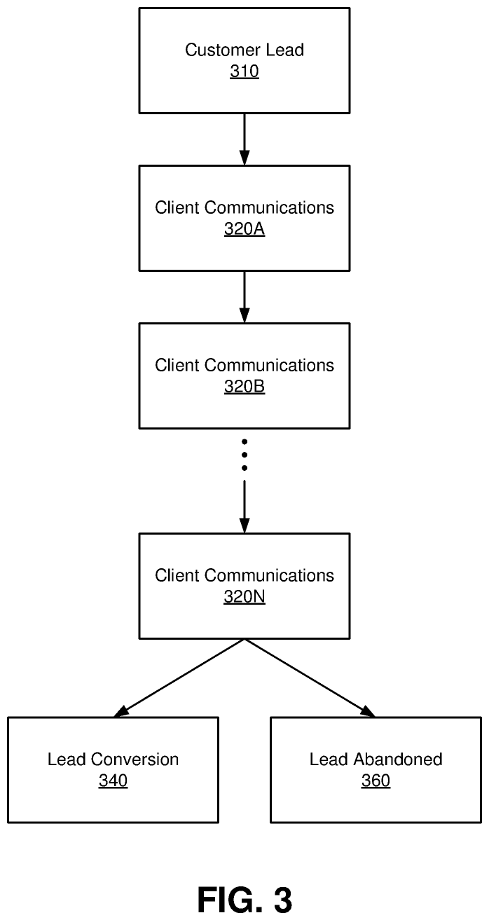

FIG. 3 is a flow diagram of the lifecycle of a lead 310, according to one or more embodiments. In some embodiments, a lead 310 in an indication that a user associated with the lead may eventually result in a conversion. Moreover, a lead 310 may include data associated with user actions in the online system 140 or third-party systems 130. The actions associated with a lead may include accessing a page corresponding to one or more content items of the online system, and communications between the user and the online system (e.g., communication between the user and an agent of the online system).

A lead 310 may result in a conversion 340 or an abandonment 360 of the lead. In some embodiments, a lead conversion results when a user associated with a lead performs a certain action in the online system. For example, a lead conversion results when the user consumes content from the online system. In one embodiment, a lead conversion results when the user associated with the lead purchase a product offered by the online system, or otherwise results in revenue being generated for the online system.

Before the lead 310 is completed (e.g., before the lead 310 results in a conversion 340 or an abandonment 360 of the lead), a set of client communications 320 (e.g., a set of messages) between the user associated with the lead and the online system may take place. Once a lead 310 is generated, the online system may send a set of messages to the user associated with the lead to increase the likelihood that the lead will result in a conversion.

In some embodiments, a lead 310 is abandoned 360 if the lead is not converted within a threshold amount of time. Alternatively, a lead 310 may be abandoned 360 if the lead is not converted within a threshold number of client communications 320. In some embodiment, a lead 310 is also abandoned 360 if a determined likelihood that the lead will result in a conversion is below a threshold value. In some embodiments, the conditions for abandoning a lead is based on parameters of the lead. For example, a threshold for abandoning a lead associated with luxury items may be higher than a threshold for abandoning non-luxury items.

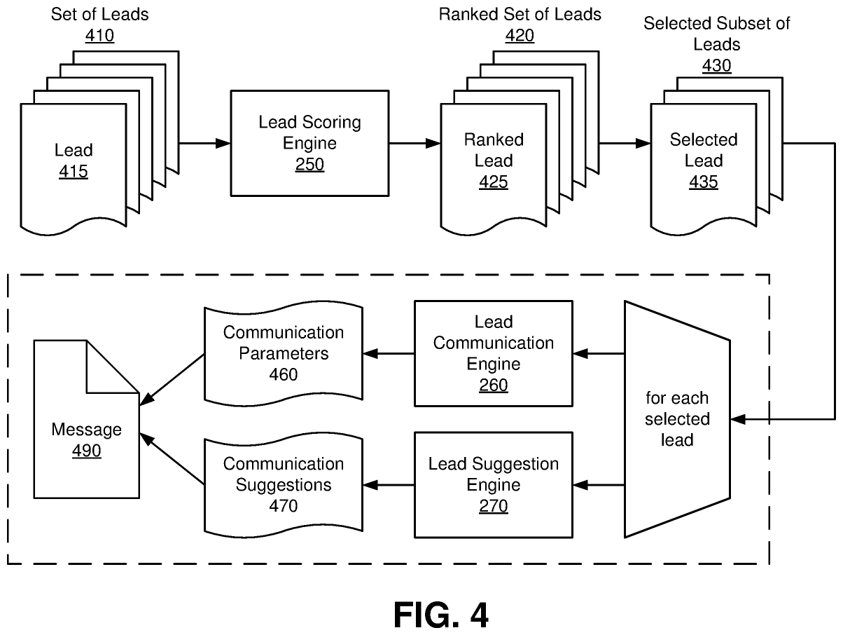

FIG. 4 is a block diagram showing an overview for following up with leads, according to one or more embodiments. In some embodiments, the steps shown in FIG. 4 are performed periodically (e.g., daily). That is, the process of FIG. 4 is performed one or more times during each period of a set of periods.

At the beginning of a period, the online system accesses a set of leads 410 (including multiple leads 415). Each lead is provided to the lead scoring engine 250. The lead scoring engine 250 generates a lead score for each of the leads 415 in the set of leads 410 and ranks the leads 410 based on their respective lead scores to generate a ranked set of leads 420. The rank set of leads 420 includes multiple ranked leads 425 ordered based on their respective lead scores. Each rank leads 425 in the set of ranked leads may correspond to a lead 415 in the starting set of leads 410.

The ranked set of leads 420 are filtered, and a subset of leads are selected from the ranked set of leads 420 to generate a selected subset of leads 430. In some embodiments, the online system 140 filters the ranked set of leads based on the lead scores of each of the leads in the ranked set of leads. For instance, the online system 140 may select leads having a lead score larger than a threshold value to form the selected subset of leads 430. Alternatively, the online system 140 filters the ranked set of leads by selecting a threshold number of leads (e.g., a top threshold number of leads) to form the selected subset of leads 430.

For each selected lead 435, the online system provides the selected lead 435 to the lead communication engine 260 and to the lead suggestion engine 270. The lead communication engine 260 receives the selected lead as an input and generates a set of communication parameters 460 as an output. The lead suggestion engine 270 receives the selected lead 435 as an input and generates a set of communication suggestions 470 as an output.

Based on the generated set of communication parameters 460 and set of communication suggestions 470, the online system 140 generates a message 490 to communicate with a user associated with the selected lead 435. Alternatively, the online system 140 may preset the set of communication parameters 460 or the set of communication suggestions 470 to an agent to aid the agent in generating a message 490 for communicating with the user associated with the selected lead 435.

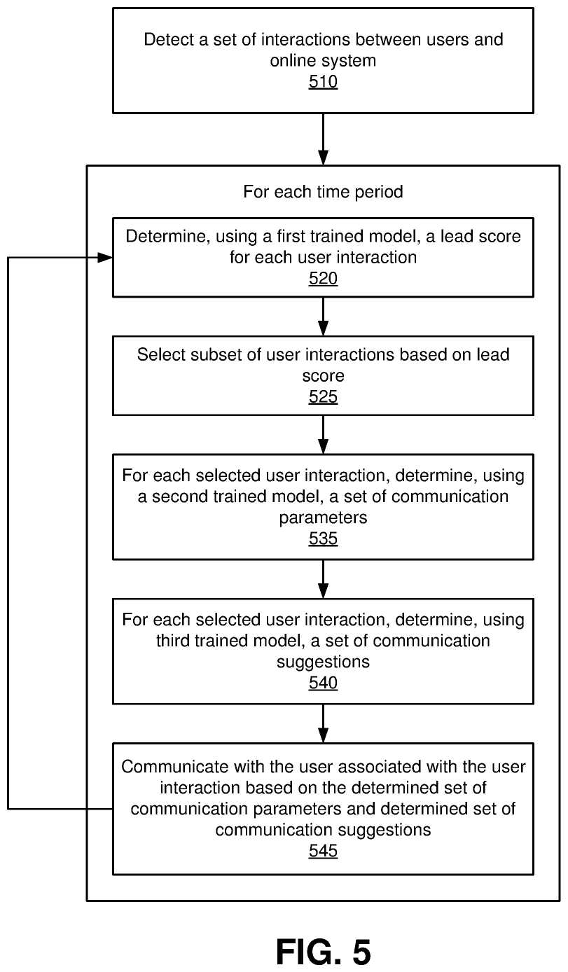

FIG. 5 is a flow diagram of a process for following up on leads, according to one or more embodiments. Alternative embodiments may include more, fewer, or different steps from those illustrated in FIG. 5, and the steps may be performed in a different order from that illustrated in FIG. 5. Additionally, each of these steps may be performed automatically by the online system without human intervention.

The online system 140 detects 510 a set of interactions between users and the online system. In some embodiments, the online system 140 detects a set of leads, each corresponding to one or more user interactions. Moreover, the user interactions of the set of user interactions may include the user accessing a page associated with a content or product of the online system, a user sensing a message to the online system regarding a content or product of the online system, and the like.

During each time period of a set of time periods, a subset of interactions is selected, and messages are sent to users associated with each of the selected interactions. To select the subset of interactions, the lead scoring engine 250 determines 520, using a lead score trained model, a lead score for each of the user interactions. In some embodiments, the lead score is indicative of a likelihood that the user interaction will result in a conversion. Moreover, the lead score may be determined based on a set of attributes of the user interaction.

In some embodiments, the lead score model is trained using a training dataset having a set of past user interactions. Each past user interaction may include a set of dynamic features describing a set of communications associated with the past interaction, and a set of static features describing a set of attributes of the user interaction.

Based on the lead scores determined by the lead scoring engine 250, the online system 140 selects 525 a subset of user interactions. In some embodiments, the online system 140 selects user interactions having a lead score higher than a threshold value. Alternatively, the online system 140 selects a threshold number of user interactions (e.g., a top threshold number of user interactions sorted by their respective lead score).

For each selected user interaction, the lead communication engine 260 determines 535, using a trained lead communication model, a set of communication parameters. In some embodiments, the set of communication parameters include a communication channel for communicating with the user associated with the user interaction. For example, the set of communication parameters may indicate whether to communicate with the user via email, text message, or phone call. In some embodiments, the set of communication parameters includes a time for communicating with the user, a frequency for communicating with the user, and the like.

In some embodiments, the lead communication model is trained to select a set of communication parameters that maximizes or increases the likelihood of conversion with the least number of communications. In some embodiments, the lead communication model uses a recurrent network with reinforcement learning.

The lead communication model may determine the set of communication parameters based at least in part on attributes of the interaction between the user associated with the user interaction and the online system (or an agent of the online system). Moreover, the lead communication model may determine the set of communication parameters based on information stored in the user profile of the user associated with the user interaction.

In some embodiments, the online system 140 presents (e.g., through a user interface of the online system) the set of communication parameters to an agent of the online system to instruct the agent of the online system to communicate with the user associated with the user interaction based on the set of communication parameters.

Referring back to FIG. 5, for each selected user interaction, the lead suggestion engine 270 determines 540, using a trained lead suggestion model, a set of communication suggestions. In some embodiments, the set of communication suggestions may include a set of talking points to include in a message to the user associated with the user interaction.

In some embodiments, if the user associated with the user interaction is an existing user of the online system (e.g., an established user of the online system) and has previously been converted, the lead suggestion model determines the set of communication suggestions based on prior conversions of the user. For example, the set of communication suggestions may be selected based on preferences of the user inferred from the prior conversions, such as, price sensitivity, brank affinity, and the like.

Alternatively, if the user associated with the user interaction is a new user that has not been previously converted, the set of communication suggestions are selected based on preferences of users with similar profiles as the user associated with the user interaction. For example, a set of users with similar profiles are identified and a set of preferences in common to the set of identified users with similar profiles are used. In some embodiments, the users are clustered based on demographics and geographic locality.

In some embodiments, based on the set of communication parameters determined by the lead communication engine 260 and the set of communication suggestions determined by the lead suggestion engine 270, the online system 140 communicates 545 with the user associated with the user interaction.

In some embodiments, after sending a message to the user associated with a user interaction, the online system determines whether feedback is received from the user. For example, the online system may determine whether the user replied to the message. The lead scoring engine 250 may then update the lead score of the user interaction based on whether feedback was received from the user.

Moreover, upon receiving a new communication from the user, the lead scoring engine determines a sentiment score for the new communication form the user. The sentiment score may be determined using a trained sentiment model based on a text or transcript of the communication form the user. The lead scoring engine 250 may then update the lead score of the user communication based on the determined sentiment score.

### Hardware Components

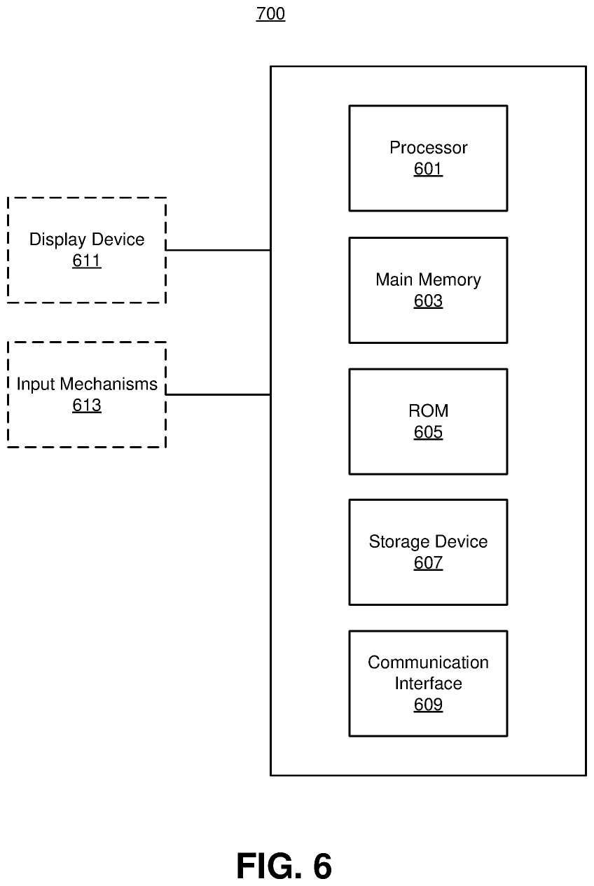

FIG. 6 is system diagram of a computer system, according to one or more embodiments. FIG. 6 illustrates a computer system 600 upon which embodiments described herein may be implemented within the online system 140 and the client devices 110. For example, in the context of FIG. 1, the online system 140 and the client devices 110 may each be implemented using a computer system such as described by FIG. 6. The online system 140 and/or the client devices 110 may also be implemented using a combination of multiple computer systems as described by FIG. 6.

In one implementation, the online system 140 and the client devices 110 each include a processor 601, main memory 603, read only memory (ROM) 605, storage device 607, and a communication interface 609. The online system 140 and the client devices 110 each includes at least one processor 601 for processing information and a main memory 603, such as a random access memory (RAM) or other dynamic storage device, for storing information and instructions to be executed by the processor 601. In one embodiment, multiple processors are employed by the online system 140 to perform the techniques described above in order to improve efficiency of the online system 140 and reduce computation time when generating the customized recommendations. Main memory 603 also may be used for storing temporary variables or other intermediate information during execution of instructions to be executed by processor 601. The online system 140 and the client devices 110 may each also include ROM 605 or other static storage device for storing static information and instructions for processor 601. The storage device 607, such as a magnetic disk or optical disk or solid state memory device, is provided for storing information and instructions.

The communication interface 609 can enable each of the online system 140 and the client devices 110 to communicate with each other through use of a communication link (wireless or wireline). Each of the online system 140 and the client devices 110 can optionally include a display device 611, such as a cathode ray tube (CRT), an LCD monitor, an LED monitor, OLED monitor, a TFT display or a television set, for example, for displaying graphics and information to a user. An input mechanism 613, such as a keyboard that includes alphanumeric keys and other keys, can optionally be coupled to the computer system 600 for communicating information and command selections to processor 601. Other non-limiting, illustrative examples of input mechanisms 613 include a mouse, a trackball, touch-sensitive screen, or cursor direction keys for communicating direction information and command selections to processor 601 and for controlling cursor movement on display device 611.

Examples described herein are related to the use of the online system 140 and the client devices 110 for implementing the techniques described herein. According to one embodiment, those techniques are performed by each of the online system 140 and the client devices 110 in response to processor 601 executing one or more sequences of one or more instructions contained in main memory 603. Such instructions may be read into main memory 603 from another machine-readable medium, such as storage device 607. Execution of the sequences of instructions contained in main memory 603 causes processor 601 to perform the process steps described herein. In alternative implementations, hard-wired circuitry may be used in place of or in combination with software instructions to implement examples described herein. Thus, the examples described are not limited to any specific combination of hardware circuitry and software. Furthermore, it has also proven convenient at times, to refer to arrangements of operations as modules, without loss of generality. The described operations and their associated modules may be embodied in software, firmware, hardware, or any combinations thereof.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for determining user interest in a vehicle on a user interface of an online system, the method comprising:
detecting a user interaction between a first user and the online system;
retrieving a set of attributes of the user interaction between the first user and the online system;
periodically determining, using a first trained machine learning (ML) model, based on the set of attributes of the user interaction, a lead score indicative of a likelihood that the user interaction will result in a conversion;
responsive to the lead score being higher than a threshold value, determining using a second trained ML model, based at least in part on attributes of the user interaction between the first user and the online system and user profile information for the first user, a set of communication parameters to communicate with the first user, wherein the second trained ML is trained to select the set of communication parameters to increase a likelihood of conversion of the first user; and
presenting the set of communication parameters to a second user of the online system to instruct the second user to communicate with the first user based on the set of communication parameters.

2. The method of claim 1, wherein the first trained ML model is trained using a first training dataset comprising a plurality of past user interactions with the online system, each past user interaction having a set of dynamic features describing a set of communications associated with the past user interaction, and a set of static features describing the set of attributes of the user interaction.

3. The method of claim 2, wherein the set of static features includes information about the first user associated with the past user interaction.

4. The method of claim 2, wherein the set of static features includes information about one or more vehicles associated with the past user interaction.

5. The method of claim 2, wherein the set of dynamic features describing the set of communications associated with a past user interaction comprises at least one of information about a channel of each communication of the set of communications, a sentiment score of each communication of the set of communications, and a frequency of communications of the set of communications.

6. The method of claim 1, wherein the second trained ML model is trained to select the set of communication parameters to maximize a likelihood of conversion with a least number of communications with the first user associated with the user interaction.

7. The method of claim 1 wherein the second trained ML model uses a recurrent network with reinforcement learning.

8. The method of claim 1, wherein the set of communication parameters determined by the second trained ML model includes a communication channel.

9. The method of claim 8, wherein the communication channel is one of an email, a text message, or a phone call.

10. The method of claim 1, wherein the set of communication parameters determined by the second trained ML model includes a frequency of communications with the first user associated with the user interaction.

11. The method of claim 1, further comprising:
responsive to receiving an indication of a new communication with the first user associated with the user interaction, determining, using a third trained ML model based on a transcript of the new communication, a sentiment score for the new communication.

12. The method of claim 11, wherein the transcript of the new communication comprises one of a transcript of a phone call with the first user associated with the user interaction, a text of an email thread with the first user associated with the user interaction, or a text of a text message chain with the first user associated with the user interaction.

13. The method of claim 11, further comprising updating the lead score based on the sentiment score for the new communication.

14. The method of claim 1, further comprising:
determining, using a fourth trained ML model, a set of talking points based on information about the first user associated with the user interaction.

15. A non-transitory computer readable medium configured to store instructions for determining user interest in a vehicle on a user interface of an online system, the instructions when executed by a processor cause the processor to:
detect a user interaction between a first user and the online system;
retrieve a set of attributes of the user interaction between the first user and the online system;
periodically determine, using a first trained machine learning (ML) model, based on the set of attributes of the user interaction, a lead score indicative of a likelihood that the user interaction will result in a conversion;
responsive to the lead score being higher than a threshold value, determine using a second trained ML model, based at least in part on attributes of the user interaction between the first user and the online system and user profile information for the first user, a set of communication parameters to communicate with the first user, wherein the second trained ML is trained to select the set of communication parameters to increase a likelihood of conversion of the first user; and
present the set of communication parameters to a second user of the online system to instruct the second user to communicate with the first user based on the set of communication parameters.

16. The non-transitory computer readable medium of claim 15, wherein the first trained ML model is trained using a first training dataset comprising a plurality of past user interactions with the online system, each past user interaction having a set of dynamic features describing a set of communications associated with the past user interaction, and a set of static features describing the set of attributes of the user interaction.

17. The non-transitory computer readable medium of claim 15, wherein the second trained ML model is trained to select the set of communication parameters to maximize a likelihood of conversion with a least number of communications with the first user associated with the user interaction.

18. A system for determining user interest in a vehicle on a user interface of an online system, comprising:
a processor, and
a non-transitory computer readable medium configured to store instructions, the instructions when executed by a processor cause the processor to:
detect a user interaction between a first user and the online system;
retrieve a set of attributes of the user interaction between the first user and the online system;
periodically determine, using a first trained machine learning (ML) model, based on the set of attributes of the user interaction, a lead score indicative of a likelihood that the user interaction will result in a conversion;
responsive to the lead score being higher than a threshold value, determine using a second trained ML model, based at least in part on attributes of the user interaction between the first user and the online system and user profile information for the first user, a set of communication parameters to communicate with the first user, wherein the second trained ML is trained to select the set of communication parameters to increase a likelihood of conversion of the first user; and
present the set of communication parameters to a second user of the online system to instruct the second user to communicate with the first user based on the set of communication parameters.

19. The system of claim 18, wherein the first trained ML model is trained using a first training dataset comprising a plurality of past user interactions with the online system, each past user interaction having a set of dynamic features describing a set of communications associated with the past user interaction, and a set of static features describing the set of attributes of the user interaction.

20. The system of claim 18, wherein the second trained ML model is trained to select the set of communication parameters to maximize a likelihood of conversion with a least number of communications with the first user associated with the user interaction.
